(19) United States
(12) Patent Application Publication
(10) Pub. No.: US 2012/0297765 A1
(43) Pub. Date: Nov. 29, 2012

(54) COOLING ARRANGEMENT FOR A CHARGEABLE INTERNAL COMBUSTION ENGINE

(75) Inventors: Christian Winge Vigild, Aldenhoven (DE); Hans Guenter Quix, Herzogenrath (DE)

(73) Assignee: FORD GLOBAL TECHNOLOGIES, LLC, Dearborn, MI (US)

(21) Appl. No.: 13/468,993

(22) Filed: May 10, 2012

(30) Foreign Application Priority Data
May 25, 2011 (DE) 102011076457.7

(51) Int. Cl. F02B 29/04; F01P 7/00

(52) U.S. Cl. 60/599; 123/41.08

(57) ABSTRACT

Embodiments for a cooling arrangement are provided. In one example, a cooling arrangement comprises a low-temperature circuit for charge-air cooling of a turbocharger of an internal combustion engine, an engine cooling circuit for cooling the internal combustion engine, and a charge-air cooler arranged in the low-temperature circuit and connected in a fluid-conducting manner on a coolant inlet side, via a first valve device, to the low-temperature circuit and to the engine cooling circuit, and on a coolant outlet side, via a second valve device, to the low-temperature circuit and to the engine cooling circuit. In this way, coolant from the engine may heat the charge-air cooler under certain conditions.

### RELATED APPLICATIONS

The present application claims priority to German Patent Application Number 102011076457.7, filed on May 25, 2011, the entire contents of which are hereby incorporated by reference for all purposes.

### FIELD

The present disclosure refers to a cooling arrangement for a chargeable internal combustion engine.

### BACKGROUND AND SUMMARY

Cooling arrangements are used, for example, in internal combustion engines, especially motor vehicle engines, with turbochargers in order to cool the internal combustion engine, using the engine cooling circuit, and to cool the charge air—which is fed to the internal combustion engine via the turbocharger—using the low-temperature cooling circuit.

Modern chargeable internal combustion engines, especially chargeable diesel engines, customarily have a charge-air cooling system by means of which the air which is required for charging the internal combustion engine is cooled. A charge-air cooling system in this case is required on the one hand on account of the heating of the turbocharger by the exhaust gases of the engine. The aforesaid heating is brought about as a result of the common arrangement of the turbine and the compressor on one shaft and the thermal contact of the two components which is associated therewith. On account of this thermal contact, a transfer of heat from the exhaust gas turbocharger to the charge-air compressor is ultimately brought about.

On the other hand, it is to be taken into consideration that the air which is inducted by means of the charge-air compressor is heated as a result of the compression customarily to a temperature of about 180° C. or, in the case of a two-stage compression, to an even higher temperature. As temperature rises, the inducted charge air expands, as a result of which a reduction of the oxygen proportion per volumetric unit is brought about. This reduction of the oxygen proportion causes a lower power increase of the engine. In order to counteract this effect, the charge-air coolers mentioned previously are also used, especially in motor vehicle engines. The use of a charge-air cooler ensures that the heated, compressed air is cooled down and consequently a higher charge density is made available to the combustion process in the cylinder, as a result of which a power increase of the internal combustion engine is made possible.

With regard to future exhaust gas and emissions regulations, particularly for diesel engines, it can be advantageous to also heat the charge air at least periodically, for example for aiding the regeneration of a diesel particulate filter provided in the exhaust gas train of the diesel engine, or in cold environmental conditions in general. The heating of the charge air could be carried out by means of an electric heater which is provided in the inlet region of the internal combustion engine. The electric heater, however, requires relatively high electric power, about 1.5 kW, for example, which could be provided by the electric generator of the motor vehicle. The higher fuel consumption which is caused by this, however, impairs the economical efficiency of the motor vehicle.

A circuit arrangement with a low-temperature circuit for cooling charge air in a motor vehicle with a turbocharger, and with an engine cooling circuit for cooling an engine, is known from WO 2004/090303 A1, for example. The low-temperature circuit can be connected to the engine cooling circuit via a mixer thermostat so that coolant can find its way from one cooling circuit into the other circuit and back, wherein the coolants from both circuits can be mixed. Heating of the charge air is provided by feeding hot coolant from the engine cooling circuit into the low-temperature circuit.

Furthermore, WO 2005/061869 A1 also discloses a circuit arrangement with a low-temperature cooling circuit for cooling charge air in a motor vehicle with a turbocharger, and with a main cooling circuit for cooling an engine. The low-temperature cooling circuit and the main cooling circuit are interconnected in a fluid-conducting manner so that mixing of the coolants from both circuits is carried out. In particular, the coolant of the main cooling circuit is branched off on a coolant inlet side of an engine and directed into the low-temperature cooling circuit for cooling the charge air. The disclosed circuit arrangement does not provide heating of the charge air.

Furthermore, an arrangement for cooling recirculated exhaust gas and charge air in a motor vehicle with a turbocharger is known from DE 10 2005 004 778 A1. Both a heat exchanger for the exhaust gas flow in an exhaust gas recirculation line and a heat exchanger for the charge air flow in a parallel connection are arranged in a low-temperature cooling circuit. The low-temperature cooling circuit additionally has an auxiliary coolant pump with which the coolant is circulated in the low-temperature cooling circuit. A restricting element is provided at the coolant outlet of the charge-air cooler in order to be able to control a distribution of the coolant throughput between the charge-air cooler and the exhaust gas cooler in dependence upon temperature. A main cooling circuit for cooling the engine is provided separately from the low-temperature cooling circuit so that mixing of the coolant from both coolant circuits is not possible.

Finally, a cooling system of a charged internal combustion engine with a charge-air feed is also to be gathered from EP 1 905 978 A2. The cooling system comprises a first and a second cooling circuit, of which the first cooling circuit is operated at a higher temperature level than the second cooling circuit and in which the charge-air feed has at least one charge-air cooling unit which is thermally connected to the second cooling circuit which has a controllable coolant throughput. That is to say, the coolant can find its way from the first circuit into the second circuit and back so that mixing of the coolant from both circuits is possible. In the disclosed cooling circuit, provision is made in the second cooling circuit for a shut-off element with which the coolant throughput in the second cooling circuit can be shut off.

The inventors herein have recognized a few issues with the above approaches. For example, in the case of two separate cooling circuits for charge-air cooling and for cooling an internal combustion engine in each case, the arrangements do not allow a short-term raising of the charge-air temperature level, and, on the other hand, in the case of two interconnectable cooling circuits, lead to mixing of the coolant of the two circuits, that is to say the low-temperature circuit and the high-temperature circuit or the engine cooling circuit. As a result of this, the heating process of the coolant from the engine cooling circuit is delayed on account of a greater thermal mass for the engine cooling circuit which consequently extends the warming-up phases of the internal combustion engine. Furthermore, mixing of hot coolant from the engine cooling circuit with the coolant of the low-temperature circuit has a disadvantageous effect with regard to an achievable minimum temperature in the low-temperature circuit.

Thus, in one embodiment, a cooling arrangement comprises a low-temperature circuit for charge-air cooling of a turbocharger of an internal combustion engine, an engine cooling circuit for cooling the internal combustion engine, and a charge-air cooler arranged in the low-temperature circuit and connected in a fluid-conducting manner on a coolant inlet side, via a first valve device, to the low-temperature circuit and to the engine cooling circuit, and on a coolant outlet side, via a second valve device, to the low-temperature circuit and to the engine cooling circuit.

In doing so, the present disclosure provides an energy-efficient cooling arrangement for a chargeable internal combustion engine, which cooling arrangement especially shortens warming-up phases of the internal combustion engine and therefore allows a periodic raising of the charge-air temperature level within the shortest time, especially with regard to defined regeneration strategies of exhaust gas aftertreatment components, for example of diesel particulate filters. The cooling arrangement which is to be disclosed, moreover, is to be simply designed with respect to control engineering and is also to enable a short-term reaction to changes of the operating parameters of the internal combustion engine, of a downstream exhaust gas aftertreatment system and/or of the state variables in the cooling circuits.

The features which are individually explained in the following description can be combined with each other in any technically expedient manner and disclose further developments of the disclosure. The description characterizes and specifies the disclosure especially in conjunction with the figures in addition.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic representation of a cooling arrangement according to an embodiment of the present disclosure.

FIG. 2 schematically shows an embodiment of a single cylinder of the multi-cylinder engine of FIG. 1.

FIG. 3 is a flow chart illustrating a method for controlling temperature of a charge-air cooler according to an embodiment of the present disclosure.

### DETAILED DESCRIPTION

According to the disclosure, a cooling arrangement comprises a low-temperature circuit for charge-air cooling of a turbocharger of an internal combustion engine, especially of a diesel engine, and an engine cooling circuit for cooling the internal combustion engine, wherein a charge-air cooler, which is arranged in the low-temperature circuit, can be connected in a fluid-conducting manner on the coolant inlet side, via a first valve device, and on the coolant outlet side, via a second valve device, to the low-temperature circuit or to the engine cooling circuit.

Accordingly, when required, that is to say if, for example, heating of the charge air is desired and the coolant temperature in the engine cooling circuit exceeds the charge-air temperature after compression by the turbocharger, the charge-air cooler can be integrated directly into the engine cooling circuit via the first and second valve devices. Therefore, on the one hand, the energy which is present in the engine cooling circuit can be used in an energy-efficient manner for heating the charge air. On the other hand, the engine cooling circuit, with the charge-air cooler integrated in, is loaded only by the thermal mass of the charge-air cooler, of the first and second valve devices and also of the pipes, for example hoses, which interconnect the charge-air cooler and the valve devices in a fluid-conducting manner and which are preferably constructed as short as possible. If, on the other hand, no heating of the charge air is required or charge-air cooling is desired, the charge-air cooler can be isolated from the engine cooling circuit via the first and second valve devices and only connected into the low-temperature circuit. In this operating state, the charge-air cooler and the first and second valve devices in essence no longer constitute an additional thermal load for the engine cooling circuit.

The cooling arrangement according to the disclosure, on account of the low thermal masses which are periodically additionally integrated into the engine cooling circuit, is therefore able to shorten the warming-up phase of the internal combustion engine to a minimum and allows an increase of the charge-air temperature level when required in a simple manner within the shortest time. The cooling arrangement according to the disclosure also enables a short-term reaction to changes of the operating parameters of the internal combustion engine, of a downstream exhaust gas aftertreatment system and/or of the state variables in the cooling circuits. Operating parameters are, for example, the respective operating temperatures of the internal combustion engine, of the exhaust gas aftertreatment system and/or of the cooling circuits or the power which is to be delivered by the internal combustion engine and the like.

In an embodiment of the disclosure, the first and second valve devices can be operated in each case in a first valve position, in which the charge-air cooler is connected in a fluid-conducting manner exclusively to the low-temperature circuit, and in a second valve position, in which the charge-air cooler is connected in a fluid-conducting manner exclusively to the engine cooling circuit. Therefore, it is ensured that the coolant of the engine cooling circuit in essence cannot mix with the coolant of the low-temperature circuit. This enables short warming-up phases of the internal combustion engine since only the coolant of the engine cooling circuit has to be heated regardless of the operating position or valve position of the first and second valve devices. Furthermore, it is ensured that in essence no hot coolant can find its way from the engine cooling circuit into the low-temperature circuit and therefore temperatures which are as low as possible can be realized in the low-temperature circuit.

A three-way valve may be utilized according to the disclosure in each case as the first and second valve devices, wherein the first three-way valve can be constructed as a so-called mixer valve and the second three-way valve can be constructed as a so-called distribution valve. Within the meaning of the present disclosure, the term “mixer valve”, however, is not to be designed to the effect that the three-way valve serves for mixing the coolants from the engine cooling circuit and the low-temperature circuit. Rather, this type of three-way valve generally describes a function of the three-way valve in which the fluid flows which are fed to the valve via two fluid inlets are transferred to a common outlet, wherein the proportions of the fluid inlet flows contained in the fluid outlet flow depend upon the valve position. The second three-way valve, which is constructed as a distribution valve, provides the function of transmitting the fluid flow, which is fed to an inlet of the valve, to two outlets, wherein the proportion of the fluid inlet flow in each fluid outlet flow depends upon the valve position. According to the disclosure, both three-way valves are operated in each case in the already mentioned first and second valve positions in which the fluid flow of an inlet is transferred in each case exclusively to an outlet of the valve. In this way, mixing of the fluid flows is avoided as a result of the three-way valves.

An embodiment of the disclosure also provides that coolant of the engine cooling circuit can be fed from a coolant outlet of the internal combustion engine to the first valve device. Therefore, a simple temperature-dependent closed-loop controlling or open-loop controlling of the valve devices is possible since the outlet temperature of the coolant from the internal combustion engine is in a direct relationship with the load of the internal combustion engine.

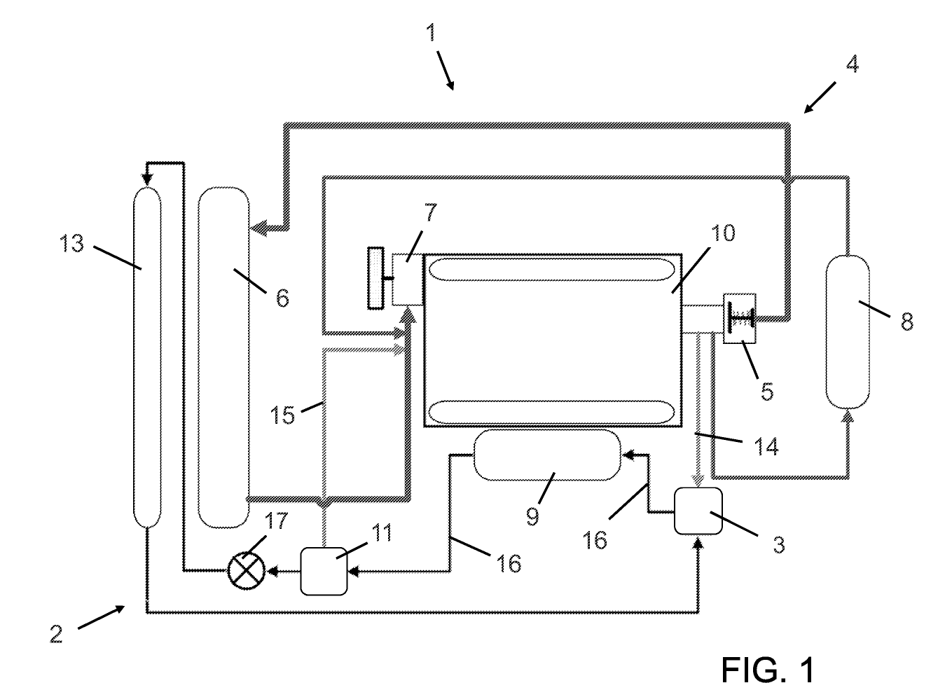

Shown schematically in FIG. 1 is an exemplary embodiment of a cooling arrangement 1 according to the disclosure. The cooling arrangement 1 comprises a low-temperature circuit 2 for charge-air cooling of a turbocharger, which is not shown in FIG. 1, of an internal combustion engine 10, for example of a diesel engine, and also an engine cooling circuit 4 for cooling the internal combustion engine 10.

The engine cooling circuit 4 shown in FIG. 1 comprises the internal combustion engine 10, which is also referred to as an engine 10 in the following text, an engine thermostat 5, an engine coolant cooler 6 (e.g., a radiator) and an engine coolant pump 7 which is driven by the engine 10 via a known belt drive, for example. In addition, a heat exchanger or a heating device 8 for heating a motor vehicle interior is connected to the engine cooling circuit 4 which is shown in FIG. 1.

As is to be gathered from FIG. 1, the low-temperature circuit 2 comprises a charge-air cooler 9, which may be a charge-air coolant cooler, which is allocated to an inlet side of the engine 10 and to the coolant inlet of which is connected a first valve device 3 in a fluid-conducting manner. A second valve device 11 is connected in a fluid-conducting manner to the coolant outlet of the charge-air cooler 9. Arranged downstream of the second valve device 11 is a coolant pump 17 for circulating the coolant in the low-temperature circuit 2, and following this is an air-cooled low-temperature coolant cooler 13.

The first and second valve devices 3, 11 are designed in each case as a three-way valve 3, 11 in the depicted exemplary embodiment. The first three-way valve 3 is constructed as a mixer valve and has two coolant inlets and one coolant outlet, whereas the second three-way valve 11 is constructed as a distribution valve with one coolant inlet and two coolant outlets. In the cooling arrangement 1 shown in FIG. 1, the first inlet of the first three-way valve 3 is connected in a fluid-conducting manner to the outlet of the low-temperature coolant cooler 13 and the second inlet is connected in a fluid-conducting manner to the engine cooling circuit 4 via a feed pipe 14. The feed pipe 14 is connected to the engine cooling circuit 4 at a coolant outlet of the engine 10 which is provided between the engine 10 and the engine thermostat 5. As a result of this, a particularly simple temperature-dependent closed-loop controlling or open-loop controlling of the valve devices 3 and 11 is possible since the outlet temperature of the coolant from the engine 10 is in a direct relationship with the load of the internal combustion engine.

The inlet of the second three-way valve 11 is connected in a fluid-conducting manner to the outlet of the charge-air cooler 9. The first outlet of the second three-way valve 11 is connected to an inlet of the coolant pump 17 and the second outlet of the three-way valve 11 is connected via a feedback line 15 to the engine cooling circuit 4, in particular to an inlet side of the engine coolant pump 7.

The first and second three-way valves 3, 11 make it possible for the charge-air cooler 9 to be connectable to the low-temperature circuit 2 and to the engine cooling circuit 4 depending upon the respective valve position of the three-way valves 3, 11. As a result of the periodic connecting of the charge-air cooler 9 into the engine cooling circuit 4, the engine cooling circuit 4 is additionally loaded only by the thermal mass of the charge-air cooler 9, of the first and second three-way valves 3, 11 and of the connecting pipes 16, for example hoses, which are arranged between the charge-air cooler 9 and the three-way valves 3, 11 and interconnect these in a fluid-conducting manner. The connecting pipes 16 are preferably constructed as short as possible.

The first and second three-way valves 3, 11 of the cooling arrangement 1 according to the disclosure are expediently designed in such a way that they can be operated in a first valve position, in which the charge-air cooler 9 is connected in a fluid-conducting manner exclusively to the low-temperature circuit 2, and in a second valve position, in which the charge-air cooler 9 is connected in a fluid-conducting manner exclusively to the engine cooling circuit 4. In essence, this prevents mixing of the coolant from the engine cooling circuit 4 with the coolant of the low-temperature circuit 2. As a result of this, the cooling arrangement 1 according to the disclosure enables warming-up phases of the engine 10 which are as short as possible since only the coolant of the engine cooling circuit 4 has to be heated regardless of the valve position of the first and second three-way valves 3, 11. Furthermore, it is ensured that in the aforesaid first valve position of the first and second three-way valves 3, 11 no hot coolant can find its way from the engine cooling circuit 4 into the low-temperature circuit 2 and therefore temperatures which are as low as possible can be realized in the low-temperature circuit 2 for cooling the charge air.

The function of the cooling arrangement 1 is now described in the following text. In a normal operating state, the first and the second three-way valves 3, 11 are operated in the first valve position, in which the charge-air cooler 9 is connected in a fluid-conducting manner exclusively to the low-temperature circuit 2. The engine cooling circuit 4 and the low-temperature circuit 2 are therefore isolated from each other with regard to the coolant flows. In this operating state, the coolant pump 17, which is arranged in the low-temperature circuit 2, circulates the coolant in the low-temperature circuit 2. The coolant which is heated by the charge-air cooler 9 yields its heat, via the air-cooled low-temperature coolant cooler 13, to the environment before it is fed again to the charge-air cooler 9 and is available for further cooling of the charge air.

In the case in which heating of the charge air is desired, for example for aiding the regeneration of a diesel particulate filter which is provided in the exhaust gas train of the engine, especially of a diesel engine, or in cold environmental conditions in general, and the coolant temperature in the engine cooling circuit 4 exceeds the charge-air temperature after compression by the turbocharger, the first and the second three-way valves 3, 11 are set in the second valve position, in which the charge-air cooler 9 is connected in a fluid-conducting manner exclusively to the engine cooling circuit 4. The charge-air cooler 9 is subsequently integrated directly into the engine cooling circuit 4 and isolated from the low-temperature circuit 2. In this operating state of the cooling arrangement 1, the coolant pump 17 is expediently shut down in order to further lower the energy consumption of the cooling arrangement 1 and therefore to increase the economical efficiency of the cooling arrangement 1 overall. The low-temperature circuit 2 is therefore completely disengaged in this operating state. The coolant pump 17 is preferably a controllable or switchable pump, especially an electrically operable coolant pump.

The hot coolant, which is fed to the charge-air cooler 9 from the coolant outlet of the engine 10 via the feed pipe 14 and the first three-way valve 3, heats the charge air in the charge-air cooler 9 and finally flows back into the engine cooling circuit 4 via the second three-way valve 11 and the feedback pipe 15. As soon as heating of the charge air is no longer necessary, the first and the second three-way valves 3, 11 are reset in the first valve position.

With the periodic connecting, according to the disclosure, of the charge-air cooler 9 into the engine cooling circuit 4, on the one hand the energy present in the engine cooling circuit 4 can be used in an energy-efficient manner for heating the charge air. On the other hand, the engine cooling circuit 4, with the charge-air cooler 9 integrated in, is loaded only by the low additional thermal mass of the charge-air cooler 9, of the three-way valves 3 and 11 and of the short connecting pipes 16. The cooling arrangement 1 according to the disclosure is therefore able to shorten the warming-up phases of the engine 10 to a minimum and, when required, also allows an increase of the charge-air temperature level within the shortest time. The cooling arrangement 1 according to the disclosure also enables a short-term reaction to changes of the operating parameters of the engine 10, of a downstream exhaust gas aftertreatment system and/or of the state variables in the respective cooling circuits 2 and 4. As operating parameters, for example the respective operating temperatures of the engine 10, of the exhaust aftertreatment system and/or of the cooling circuits 2 and 4 or the power delivered by the engine 10, and the like, can be used.

The previously described cooling arrangement according to the disclosure is not limited to the embodiment which is disclosed herein but also covers equally effective further embodiments.

In one embodiment, the cooling arrangement according to the disclosure is used in a motor vehicle with a chargeable internal combustion engine, especially in a chargeable diesel engine. It comprises a low-temperature circuit for charge-air cooling of a turbocharger of the internal combustion engine and an engine cooling circuit for cooling of the internal combustion engine, wherein a charge-air cooler, which is arranged in the low-temperature circuit, can be connected in a fluid-conducting manner on the coolant inlet side, via a first valve device, and on the coolant outlet side, via a second valve device, to the low-temperature circuit or to the engine cooling circuit. The valve positions of the first and second valve devices, which are preferably constructed in each case as a three-way valve, are expediently controlled by means of an electric actuating device in dependence upon predeterminable operating parameters of the internal combustion engine, of a downstream exhaust gas aftertreatment system and/or of the state variables in the circuits, wherein the first and second valve devices can be operated in each case in a first valve position, in which the charge-air cooler is connected in a fluid-conducting manner exclusively to the low-temperature circuit, and in a second valve position, in which the charge-air cooler is connected in a fluid-conducting manner exclusively to the engine cooling circuit.

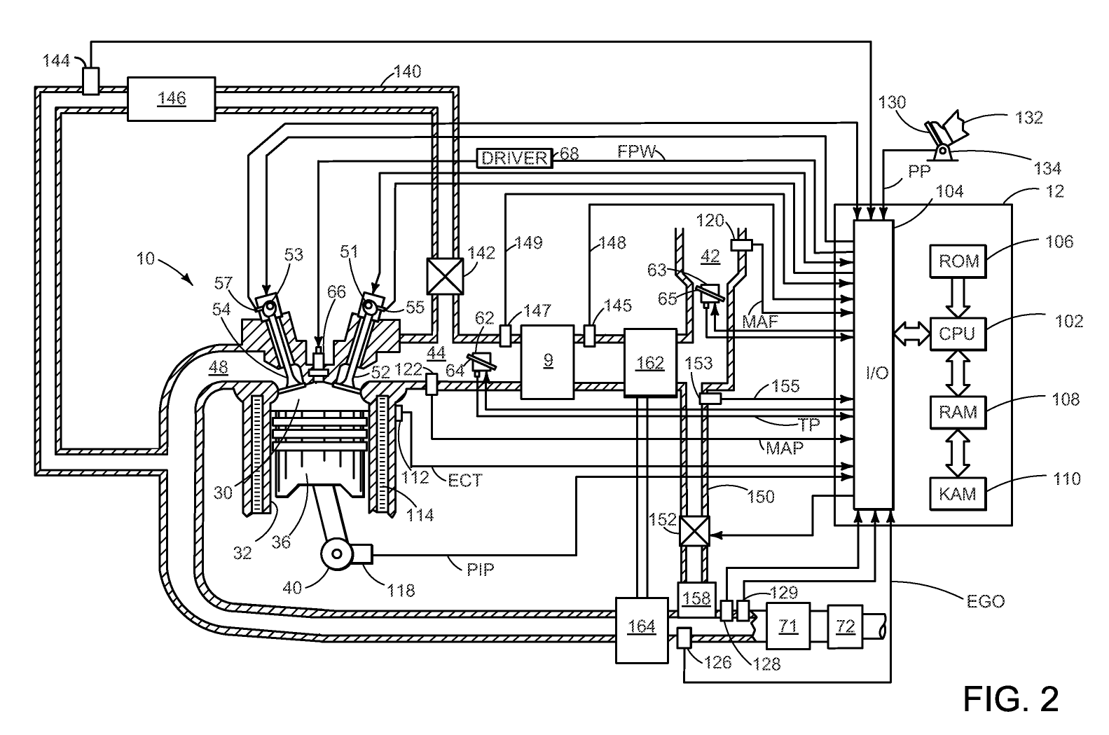

Referring now to FIG. 2, it shows a schematic diagram of one cylinder of multi-cylinder engine 10, which may be included in a propulsion system of an automobile, is shown. Engine 10 may be controlled at least partially by a control system including controller 12 and by input from a vehicle operator 132 via an input device 130. In this example, input device 130 includes an accelerator pedal and a pedal position sensor 134 for generating a proportional pedal position signal PP. Combustion chamber (i.e., cylinder) 30 of engine 10 may include combustion chamber walls 32 with piston 36 positioned therein. In some embodiments, the face of piston 36 inside cylinder 30 may have a bowl. Piston 36 may be coupled to crankshaft 40 so that reciprocating motion of the piston is translated into rotational motion of the crankshaft. Crankshaft 40 may be coupled to at least one drive wheel of a vehicle via an intermediate transmission system. Further, a starter motor may be coupled to crankshaft 40 via a flywheel to enable a starting operation of engine 10.

Combustion chamber 30 may receive intake air from intake manifold 44 via intake passage 42 and may exhaust combustion gases via exhaust passage 48. Intake manifold 44 and exhaust passage 48 can selectively communicate with combustion chamber 30 via respective intake valve 52 and exhaust valve 54. In some embodiments, combustion chamber 30 may include two or more intake valves and/or two or more exhaust valves.

In this example, intake valve 52 and exhaust valves 54 may be controlled by cam actuation via respective cam actuation systems 51 and 53. Cam actuation systems 51 and 53 may each include one or more cams and may utilize one or more of cam profile switching (CPS), variable cam timing (VCT), variable valve timing (VVT) and/or variable valve lift (VVL) systems that may be operated by controller 12 to vary valve operation. The position of intake valve 52 and exhaust valve 54 may be determined by position sensors 55 and 57, respectively. In alternative embodiments, intake valve 52 and/or exhaust valve 54 may be controlled by electric valve actuation. For example, cylinder 30 may alternatively include an intake valve controlled via electric valve actuation and an exhaust valve controlled via cam actuation including CPS and/or VCT systems.

Fuel injector 66 is shown coupled directly to combustion chamber 30 for injecting fuel directly therein in proportion to the pulse width of signal FPW received from controller 12 via electronic driver 68. In this manner, fuel injector 66 provides what is known as direct injection of fuel into combustion chamber 30. The fuel injector may be mounted in the side of the combustion chamber or in the top of the combustion chamber, for example. Fuel may be delivered to fuel injector 66 by a fuel system (not shown) including a fuel tank, a fuel pump, and a fuel rail.

Combustion in engine 10 can be of various types, depending on operating conditions. While FIG. 2 depicts a compression ignition engine, it will be appreciated that the embodiments described herein may be used in any suitable engine, including but not limited to, diesel and gasoline compression ignition engines, spark ignition engines, direct or port injection engines, etc. Further, various fuels and/or fuel mixtures such as diesel, bio-diesel, etc, may be used.

Intake passage 42 may include throttles 62 and 63 having throttle plates 64 and 65, respectively. In this particular example, the positions of throttle plates 64 and 65 may be varied by controller 12 via signals provided to an electric motor or actuator included with throttles 62 and 63, a configuration that is commonly referred to as electronic throttle control (ETC). In this manner, throttles 62 and 63 may be operated to vary the intake air provided to combustion chamber 30 among other engine cylinders. The positions of throttle plates 64 and 65 may be provided to controller 12 by throttle position signals TP. Pressure, temperature, and mass air flow may be measured at various points along intake passage 42 and intake manifold 44. For example, intake passage 42 may include a mass air flow sensor 120 for measuring clean air mass flow entering through throttle 63. The clean air mass flow may be communicated to controller 12 via the MAF signal.

Engine 10 may further include a compression device such as a turbocharger or supercharger including at least a compressor 162 arranged upstream of intake manifold 44. For a turbocharger, compressor 162 may be at least partially driven by a turbine 164 (e.g., via a shaft) arranged along exhaust passage 48. For a supercharger, compressor 162 may be at least partially driven by the engine and/or an electric machine, and may not include a turbine. Thus, the amount of compression provided to one or more cylinders of the engine via a turbocharger or supercharger may be varied by controller 12. Various turbocharger arrangements may be used. For example, a variable nozzle turbocharger (VNT) may be used when a variable area nozzle is placed upstream and/or downstream of the turbine in the exhaust line for varying the effective expansion of gasses through the turbine. Still other approaches may be used for varying expansion in the exhaust, such as a waste gate valve.

A charge air cooler 9 may be included downstream from compressor 162 and upstream of intake valve 52. Charge air cooler 9 may be configured to cool gases that have been heated by compression via compressor 162, for example. In one embodiment, charge air cooler 9 may be upstream of throttle 62. Pressure, temperature, and mass air flow may be measured downstream of compressor 162, such as with sensor 145 or 147. The measured results may be communicated to controller 12 from sensors 145 and 147 via signals 148 and 149, respectively. Pressure and temperature may be measured upstream of compressor 162, such as with sensor 153, and communicated to controller 12 via signal 155.

Further, in the disclosed embodiments, an EGR system may route a desired portion of exhaust gas from exhaust passage 48 to intake manifold 44. FIG. 2 shows an HP-EGR system and an LP-EGR system, but an alternative embodiment may include only an LP-EGR system. The HP-EGR is routed through HP-EGR passage 140 from upstream of turbine 164 to downstream of compressor 162. The amount of HP-EGR provided to intake manifold 44 may be varied by controller 12 via HP-EGR valve 142. The LP-EGR is routed through LP-EGR passage 150 from downstream of turbine 164 to upstream of compressor 162. The amount of LP-EGR provided to intake manifold 44 may be varied by controller 12 via LP-EGR valve 152. The HP-EGR system may include HP-EGR cooler 146 and the LP-EGR system may include LP-EGR cooler 158 to reject heat from the EGR gases to engine coolant, for example.

Under some conditions, the EGR system may be used to regulate the temperature of the air and fuel mixture within combustion chamber 30. Thus, it may be desirable to measure or estimate the EGR mass flow. EGR sensors may be arranged within EGR passages and may provide an indication of one or more of mass flow, pressure, temperature, concentration of O₂, and concentration of the exhaust gas. For example, an HP-EGR sensor 144 may be arranged within HP-EGR passage 140.

In some embodiments, one or more sensors may be positioned within LP-EGR passage 150 to provide an indication of one or more of a pressure, temperature, and air-fuel ratio of exhaust gas recirculated through the LP-EGR passage. Exhaust gas diverted through LP-EGR passage 150 may be diluted with fresh intake air at a mixing point located at the junction of LP-EGR passage 150 and intake passage 42. Specifically, by adjusting LP-EGR valve 152 in coordination with first air intake throttle 63 (positioned in the air intake passage of the engine intake, upstream of the compressor), a dilution of the EGR flow may be adjusted.

A percent dilution of the LP-EGR flow may be inferred from the output of a sensor 145 in the engine intake gas stream. Specifically, sensor 145 may be positioned downstream of first intake throttle 63, downstream of LP-EGR valve 152, and upstream of second main intake throttle 62, such that the LP-EGR dilution at or close to the main intake throttle may be accurately determined. Sensor 145 may be, for example, an oxygen sensor such as a UEGO sensor.

Exhaust gas sensor 126 is shown coupled to exhaust passage 48 downstream of turbine 164. Sensor 126 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), HC, or CO sensor. Further, exhaust passage 48 may include additional sensors, including a NOx sensor 128 and a particulate matter (PM) sensor 129, which indicates PM mass and/or concentration in the exhaust gas. In one example, the PM sensor may operate by accumulating soot particles over time and providing an indication of the degree of accumulation as a measure of exhaust soot levels.

Emission control devices 71 and 72 are shown arranged along exhaust passage 48 downstream of exhaust gas sensor 126. Devices 71 and 72 may be a selective catalytic reduction (SCR) system, three way catalyst (TWC), NO_{X} trap, various other emission control devices, or combinations thereof. For example, device 71 may be a TWC and device 72 may be a particulate filter (PF). In some embodiments, PF 72 may be located downstream of TWC 71 (as shown in FIG. 2), while in other embodiments, PF 72 may be positioned upstream of TWC 72 (not shown in FIG. 2).

Controller 12 is shown in FIG. 2 as a microcomputer, including microprocessor unit 102, input/output ports 104, an electronic storage medium for executable programs and calibration values shown as read only memory chip 106 in this particular example, random access memory 108, keep alive memory 110, and a data bus. Controller 12 may receive various signals from sensors coupled to engine 10, in addition to those signals previously discussed, including measurement of inducted mass air flow (MAF) from mass air flow sensor 120; engine coolant temperature (ECT) from temperature sensor 112 coupled to cooling sleeve 114; a profile ignition pickup signal (PIP) from Hall effect sensor 118 (or other type) coupled to crankshaft 40; throttle position (TP) from a throttle position sensor; and absolute manifold pressure signal, MAP, from sensor 122. Engine speed signal, RPM, may be generated by controller 12 from signal PIP. Manifold pressure signal MAP from a manifold pressure sensor may be used to provide an indication of vacuum, or pressure, in the intake manifold. Note that various combinations of the above sensors may be used, such as a MAF sensor without a MAP sensor, or vice versa. During stoichiometric operation, the MAP sensor can give an indication of engine torque. Further, this sensor, along with the detected engine speed, can provide an estimate of charge (including air) inducted into the cylinder. In one example, sensor 118, which is also used as an engine speed sensor, may produce a predetermined number of equally spaced pulses every revolution of the crankshaft.

Storage medium read-only memory 106 can be programmed with computer readable data representing instructions executable by processor 102 for performing the methods described below as well as other variants that are anticipated but not specifically listed.

As described above, FIG. 2 shows only one cylinder of a multi-cylinder engine, and that each cylinder may similarly include its own set of intake/exhaust valves, fuel injector, etc.

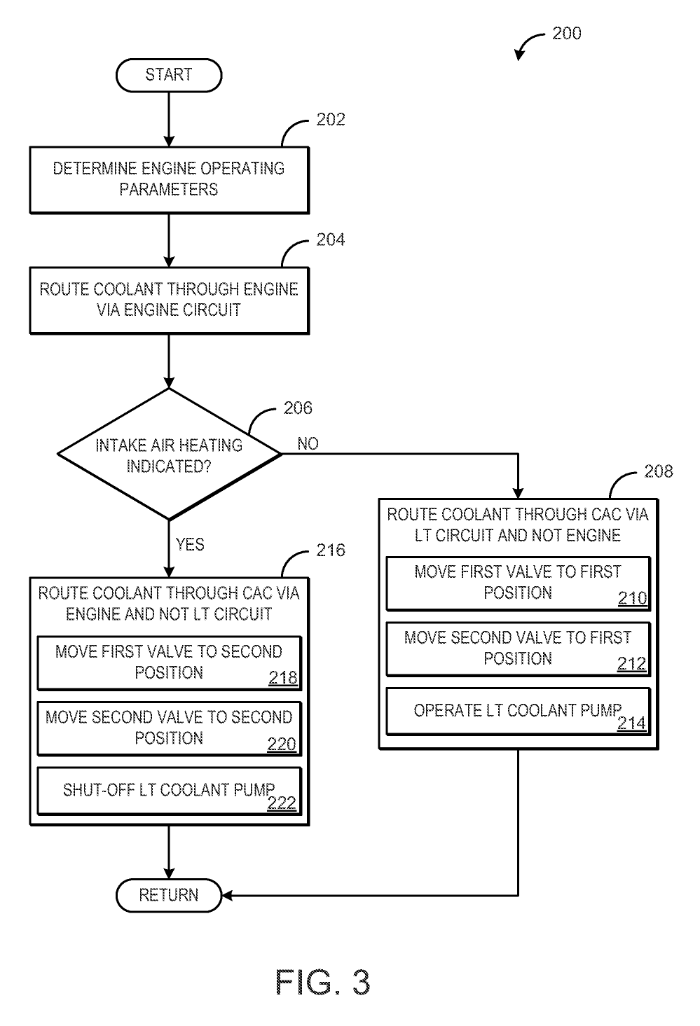

FIG. 3 is a flow chart illustrating a method 200 for controlling temperature of a charge-air cooler of an engine, such as charge-air cooler 9 of FIGS. 1 and 2. Method 200 may be carried out by controller 12. Method 200 may route coolant through the engine, and depending in operating conditions, route coolant from the engine to the charge-air cooler or route coolant from a low-temperature coolant circuit through the charge-air cooler. Thus, during a first condition, such as when engine temperature is low, coolant is routed through the charge-air cooler from the engine, while during a second condition, such as when engine temperature is high, coolant is routed through the charge-air cooler from the low-temperature circuit. The first and second conditions may be mutually exclusive in that the coolant through the charge-air cooler is either only routed from the engine or only routed from the low-temperature circuit.

At 202, method 200 comprises determining engine operating parameters. Engine operating parameters may include engine speed, engine load, engine temperature, particulate filter soot load, etc. At 204 coolant is routed through the engine via the engine circuit. As explained above with respect to FIG. 1, the engine coolant circuit comprises routing coolant through the engine via an engine coolant pump. After exiting the engine, the coolant is routed through the cabin heater, radiator, and/or charge-air cooler, depending on conditions. For example, when engine temperature is below a threshold, such as normal operating temperature (e.g., 150° C.), the coolant may be routed through the cabin heater and the charge-air cooler. Once engine temperature reaches the threshold, the coolant may then be routed through the cabin heater and the radiator.

At 206, it is determined if intake air heating is indicated. The intake air may be heated via the charge-air cooler under select conditions. The select conditions include engine temperature below a threshold (such as normal engine operating temperature) or engine load below a threshold. In another example, the select conditions include a particulate filter or EGR cooler undergoing a regeneration event. During regeneration, the temperature of the exhaust may be increased to increase the temperature of the particulate filter or cooler in order to burn off accumulated soot. To expedite exhaust heating, the intake air may be heated. Entry into particulate filter regeneration or EGR cooler regeneration may be determined based on an amount of time since a previous regeneration event, soot load on the filter or cooler, exhaust backpressure, etc.

If intake air heating is not indicated, method 200 proceeds to 208 to route coolant through the charge-air cooler via the low-temperature (LT) circuit and not the engine. The intake air may be cooled or maintained at the same temperature while flowing through the charge-air cooler during most operating conditions. For example, when operating under standard operating temperature without filter or cooler regeneration, cooling of the intake air post-compressor is desired, and thus the charge-cooler is cooled via coolant from the LT circuit. This includes, at 210, moving the first valve upstream of the charge-air cooler to a first position. The first valve may be a three-way valve that includes a selectable inlet. The first position may include the valve coupling the LT radiator (e.g., low-temperature coolant cooler 13) to the charge-air cooler such that coolant exiting the LT radiator enters the charge-air cooler via a first inlet of the first valve. At 212, the second valve downstream of the charge-air cooler is moved to a first position. The second valve may be a three-way valve that includes a selectable outlet. The first position of the second valve may include coupling the charge-air cooler to the LT radiator such that coolant exiting the charge-air cooler enters the LT radiator via the first outlet of the second valve. Routing coolant to the charge-air cooler via the LT circuit also includes, at 214, operating an LT circuit coolant pump (e.g., pump 17) arranged between the second valve and the LT radiator. In this way, coolant is routed through the charge-air cooler only from the LT circuit, which maintains the charge-air cooler at a low temperature in order to cool the intake air.

If heating of the intake air is indicated, that is if engine temperature is below the threshold or if a regeneration event is occurring, method 200 proceeds to 216 to route coolant through the charge-air cooler via the engine circuit and not the LT circuit. This includes, at 218, moving the first valve to a second position and, at 220, moving the second valve to a second position. The second position of the first valve couples the engine coolant circuit to the charge-air cooler such that coolant exiting the engine is routed through a second inlet of the first valve to the charge-air cooler. The second position of the second valve routes coolant exiting the charge-air cooler to the engine via a second outlet of the second valve. The LT coolant circuit pump (e.g., pump 17) is shut off at 222, as coolant is pumped through the charge-air cooler with the engine circuit pump (e.g., pump 7). In this way, coolant is routed from the engine to the charge-air cooler in order to heat the charge-air cooler to engine temperature. Thus, intake air entering the charge-air cooler may be heated. Upon routing coolant through the charge-air cooler, either from the LT circuit at 208 or from the engine at 216, method 200 returns.

Thus, method 200 of FIG. 3 provides for an engine method comprising under a first condition, routing coolant from a low-temperature circuit and not the engine through a charge-air cooler, and under a second condition, routing coolant from the engine and not the low-temperature circuit through the charge-air cooler. The first condition may comprise engine temperature above a threshold. The second condition may comprise engine temperature below a threshold, a regeneration operation of a particulate filter coupled to the engine, or a regeneration operation of an EGR cooler coupled to the engine. The first and second conditions may be mutually exclusive conditions. The method also includes, during the first condition, opening a first inlet of a first valve upstream of the charge-air cooler and opening a first outlet of a second valve downstream of the charge-air cooler. The method includes, during the second condition, opening a second inlet of the first valve and opening a second outlet of the second valve.

In another example, an engine method comprises routing coolant through the engine via an engine circuit, and during select conditions, heating intake air prior to reaching the engine by routing the coolant from the engine circuit to a charge-air cooler. The select conditions may comprise cold engine start conditions, regeneration operation of a diesel particulate filter, or a regeneration operation of an EGR cooler. The method also includes when engine temperature is above a threshold, cooling the intake air prior to reaching the engine by routing coolant from a low-temperature circuit to the charge-air cooler.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A cooling arrangement, comprising:
a low-temperature circuit for charge-air cooling of a turbocharger of an internal combustion engine;
an engine cooling circuit for cooling the internal combustion engine; and
a charge-air cooler arranged in the low-temperature circuit and connected in a fluid-conducting manner on a coolant inlet side, via a first valve device, to the low-temperature circuit and to the engine cooling circuit, and on a coolant outlet side, via a second valve device, to the low-temperature circuit and to the engine cooling circuit.

2. The cooling arrangement of claim 1, further comprising a controller including instructions to, during a first condition, move the first and second valve devices to a first position and operate a pump in the low-temperature circuit in order to route coolant through the charge-air cooler only via the low-temperature circuit.

3. The cooling arrangement of claim 2, wherein the first condition comprises engine temperature above a threshold.

4. The cooling arrangement of claim 2, wherein the first condition comprises engine load above a threshold.

5. The cooling arrangement of claim 2, wherein the controller includes instructions to, during a second condition, move the first and second valve devices to a second position and deactivate the pump in order to route coolant through the charge-air cooler only via the high-temperature circuit.

6. The cooling arrangement of claim 5, wherein the second condition comprises engine temperature below a threshold.

7. The cooling arrangement of claim 5, wherein the second condition comprises a regeneration operation of a particulate filter coupled to the engine.

8. An engine method, comprising:
under a first condition, routing coolant from a low-temperature circuit and not the engine through a charge-air cooler; and
under a second condition, routing coolant from the engine and not the low-temperature circuit through the charge-air cooler.

9. The engine method of claim 8, wherein the first condition comprises engine temperature above a threshold.

10. The engine method of claim 8, wherein the second condition comprises engine temperature below a threshold, the first and second conditions being mutually exclusive.

11. The engine method of claim 8, wherein the second condition comprises a regeneration operation of a particulate filter coupled to the engine.

12. The engine method of claim 8, wherein the second condition comprises a regeneration operation of an EGR cooler coupled to the engine.

13. The engine method of claim 8, wherein routing coolant from the low-temperature circuit and not the engine through the charge-air cooler further comprises opening a first inlet of a first valve upstream of the charge-air cooler and opening a first outlet of a second valve downstream of the charge-air cooler.

14. The engine method of claim 12, wherein routing coolant from the engine and not the low-temperature circuit through the charge-air cooler further comprises opening a second inlet of the first valve and opening a second outlet of the second valve.

15. An engine method, comprising:
routing coolant through the engine via an engine circuit;
during select conditions, heating intake air prior to reaching the engine by routing the coolant from the engine circuit to a charge-air cooler.

16. The engine method of claim 15, wherein the select conditions comprise cold engine start conditions.

17. The engine method of claim 15, wherein the select conditions comprise a regeneration operation of a diesel particulate filter.

18. The engine method of claim 15, wherein the select conditions comprise a regeneration operation of an EGR cooler.

19. The engine method of claim 15, further comprising, when engine temperature is above a threshold, cooling the intake air prior to reaching the engine by routing coolant from a low-temperature circuit to the charge-air cooler.
